(19) United States
(12) Patent Application Publication
(10) Pub. No.: US 2017/0177144 A1
(43) Pub. Date: Jun. 22, 2017

(54) TOUCH DISPLAY DEVICE AND TOUCH DISPLAY METHOD

(71) Applicant: BOE TECHNOLOGY GROUP CO., LTD., Beijing (CN)

(72) Inventor: Wenbo LI, Beijing (CN)

(73) Assignee: BOE Technology Group Co., Ltd., Beijing (CN)

(21) Appl. No.: 15/301,719

(22) PCT Filed: Jan. 18, 2016
(86) PCT No.: PCT/CN2016/071171

§ 371 Date: Oct. 4, 2016

(30) Foreign Application Priority Data
Aug. 20, 2015 (CN) 201510515461.7

(51) Int. Cl. G06F 3/041

(52) U.S. Cl. CPC G06F 3/0416; G06F 3/0412

(57) ABSTRACT

The present disclosure provides a touch display device and a touch display method. The touch display device includes a display panel, a plurality of detection elements arranged on the display panel and configured to acquire a sound vibration signal generated in the case that a respective body part is in contact with the display panel, a central processor connected to the detection elements and configured to analyze the sound vibration signal delivered by the detection elements, determine a body touch type, and generate an instruction signal containing the body touch type, a control chip connected to the central processor and configured to receive the instruction signal from the central processor, and generate image data and a driving signal in accordance with the instruction signal; and an image processor connected to the control chip and configured to receive the image data and the driving signal from the control chip, and drive the display panel to display a corresponding image.

### CROSS-REFERENCE TO RELATED APPLICATION

The present application claims a priority of the Chinese Patent Application No.201510515461.7 filed on Aug. 20, 2015, which is incorporated herein by reference in its entirety.

### TECHNICAL FIELD

The present disclosure relates to the field of touch technology, in particular to a touch display device and a touch display method.

### BACKGROUND

Along with the development of the touch technology, touch devices having a touch function have gradually become standard components of various portable mobile terminals. Through a touch panel, a user may input coordinate information to the mobile terminal with his hand. Like a mouse and a keyboard, the touch panel is also an input device. The touch panel has such advantages as being durable, rapid response, being space-saving, and being convenient for communication. For example, a smart mobile phone having a touch panel may have a large screen and provide more functions. The smart mobile phone having the large-size screen may be used to browse a full webpage and view a video, so as to improve a display effect and the user experience.

There are various types of touch technologies, such as a resistive type, a capacitive type, an infrared type or an electromagnetic type. In addition, the touch technologies may include a single-point touch technology and a multi-point touch technology which may be used to improve the sensitivity. Currently, the touch technologies have been gradually matured.

However, usually for the conventional touch technologies, a touch operation needs to be made by the user with his hand, e.g., a finger or a stylus. For the disabled people without hands or feet, it is impossible for the conventional touch technologies to meet their requirements.

### SUMMARY

An object of the present disclosure is to provide a touch display device and a touch display method, so as to enable a disabled person to perform touch operations through different body parts and control a display panel to display an image through these touch operations, thereby to facilitate the use of the touch display device.

In one aspect, the present disclosure provides in some embodiments a touch display device, including: a display panel; a plurality of detection elements arranged on the display panel and configured to acquire a sound vibration signal generated in the case that a respective body part is in contact with the display panel; a central processor connected to the detection elements and configured to analyze the sound vibration signal delivered by the detection elements, determine a body touch type, and generate an instruction signal containing the body touch type; a control chip connected to the central processor and configured to receive the instruction signal from the central processor, and generate image data and a driving signal in accordance with the instruction signal; and an image processor connected to the control chip and configured to receive the image data and the driving signal from the control chip, and drive the display panel to display a corresponding image.

Optionally, the touch display device further includes a sound feature signal database configured to store a correspondence between sound feature signals and body touch types. The central processor is configured to acquire a sound feature signal in accordance with the sound vibration signal, and determine the body touch type corresponding to the sound feature signal in accordance with the correspondence.

Optionally, the central processor is further configured to acquire the sound feature signal in accordance with the received sound vibration signal, receive the body touch type corresponding to the sound vibration signal, and send the sound feature signal and the body touch type to the sound feature signal database. The sound feature signal database is further configured to update the correspondence between the sound feature signals and the body touch types in accordance with the received sound feature signal and body touch type.

Optionally, the body touch type includes a single-type touch operation which is a touch operation made by a single body part and a multi-type touch operation which is a combination of touch operations made by at least two body parts.

Optionally, the central processor includes: a sampling module configured to receive the sound vibration signal from the detection element; a signal processing module configured to process the sound vibration signal and acquire a sound parameter of the sound vibration signal; a feature extraction module configured to extract a feature from the sound vibration signal in accordance with the acquired sound parameter, to obtain the sound feature signal; and a comparison module configured to compare the acquired sound feature signal with data in the sound feature signal database, so as to determine the body touch type corresponding to the sound feature signal.

Optionally, the touch display device further includes a triggering event database configured to store a correspondence between body touch types and triggering events. The control chip is configured to compare the body touch type contained in the received instruction signal with information in the triggering event database, so as to determine the image data and the driving signal corresponding to the body touch type.

Optionally, the touch display device further includes a plurality of touch sensors arranged on the display panel and configured to acquire a coordinate position of a touch point in the case that the respective body part is in contact with the touch panel. The central processor is further connected to each touch sensor, and configured to generate the instruction signal containing the body touch type and the coordinate position of the touch point.

Optionally, the triggering event database is further configured to store a correspondence between coordinate positions of touch points as well as body touch types and triggering events. The control chip is configured to compare the body touch type and the coordinate position of the touch point contained in the received instruction signal with information in the triggering event database, so as to determine the image data and the driving signal corresponding to the body touch type and the coordinate position of the touch point.

Optionally, the touch display device further includes a data storage unit connected to the control chip and configured to store therein an instruction signal for a current frame received by the control chip.

Optionally, the touch display device further includes a cache unit connected to the control chip and configured to cache an instruction signal for a next frame received by the control chip.

In another aspect, the present disclosure provides in some embodiments a touch display method for use in the above-mentioned touch display device, including steps of: acquiring a sound vibration signal generated in the case that a respective body part is in contact with a display panel; analyzing the sound vibration signal, determining a body touch type, and generating an instruction signal containing the body touch type; generating image data and a driving signal in accordance with the instruction signal; and driving the display panel to display a corresponding image in accordance with the image data and the driving signal.

Optionally, the method further includes acquiring a coordinate position of a touch point in the case that the respective body part is in contact with the display panel, and the step of generating the instruction signal containing the body touch type includes generating the instruction signal containing the body touch type and the coordinate position of the touch point.

According to the embodiments of the present disclosure, the plurality of detection elements is arranged on the display panel, so as to acquire the sound vibration signal generated in the case that the respective body part is in contact with the display panel. Then, the central processor determines the body touch type in accordance with the sound vibration signal, and generates the corresponding instruction signal. The control chip receives the instruction signal, and generates the corresponding image data and driving signal. And then, the image processor receives the image data and the driving signal, and drives the display panel to display the corresponding image. In this way, it is able to identify the body part that is in contact with the display panel, so as to achieve different touch operations through different body parts, thereby to control the display panel to display the corresponding panel. For example, in the case that a touch operation is made by a forehead, it is able to achieve a determination function; in the case that a touch operation is made by a chin, it is able to achieve a cancellation function; in the case that a touch operation is made by a nasal tip, it is able to achieve a double-click function; and in the case that a touch operation is made by a toe, it is able to achieve a drawing function. As a result, it is able to control the display panel to display the corresponding image through these touch operations, thereby to facilitate the use of the touch display device by a disabled person.

### BRIEF DESCRIPTION OF THE DRAWINGS

FIG. 1 is a schematic view showing a touch display device according to one embodiment of the present disclosure;

FIG. 2 is a schematic view showing a central processor according to one embodiment of the present disclosure;

FIG. 3 is another schematic view showing the touch display device according to one embodiment of the present disclosure;

FIG. 4 is a flow chart of a touch display method according to one embodiment of the present disclosure;

FIG. 5 is another flow chart of the touch display method according to one embodiment of the present disclosure; and

FIG. 6 is a schematic view showing body touch types including a single-type touch operation and a multi-type touch operation according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

The embodiments of the present disclosure aims to provide a touch display device and a touch display method, so as to enable a disabled person to perform touch operations through different body parts and control a display panel to display an image through these touch operations, thereby to facilitate the use of the touch display device.

The present disclosure provides in some embodiments a touch display device which, as shown in FIG. 1, includes: a display panel 50; a plurality of detection elements 10 arranged on the display panel 50 and configured to acquire a sound vibration signal generated in the case that a respective body part is in contact with the display panel 50; a central processor 20 connected to the detection elements 10 and configured to analyze the sound vibration signal delivered by the detection elements 10, determine a body touch type, and generate an instruction signal containing the body touch type; a control chip 30 connected to the central processor 20 and configured to receive the instruction signal from the central processor 20, and generate image data and a driving signal in accordance with the instruction signal; and an image processor 40 connected to the control chip 30 and configured to receive the image data and the driving signal from the control chip 30, and drive the display panel 50 to display a corresponding image. The detection elements 10 may be arranged on the display panel 50 in rows and columns. To be specific, the number of the detection elements depends on a sensing accuracy. In the case that a high sensing accuracy is desired, more detection elements may be provided, and in the case that a low sensing accuracy is desired, fewer detection elements may be provided. Specifically, the detection element may be a sound sensor.

According to the embodiments of the present disclosure, the plurality of detection elements is arranged on the display panel, so as to acquire the sound vibration signal generated in the case that the respective body part is in contact with the display panel. Then, the central processor determines the body touch type in accordance with the sound vibration signal, and generates the corresponding instruction signal. The control chip receives the instruction signal, and generates the corresponding image data and driving signal. And then, the image processor receives the image data and the driving signal, and drives the display panel to display the corresponding image. In this way, it is able to identify the body part that is in contact with the display panel, so as to achieve different touch operations through different body parts, thereby to control the display panel to display the corresponding panel. For example, in the case that a touch operation is made by a forehead, it is able to achieve a determination function; in the case that a touch operation is made by a chin, it is able to achieve a cancellation function; in the case that a touch operation is made by a nasal tip, it is able to achieve a double-click function; and in the case that a touch operation is made by a toe, it is able to achieve a drawing function. As a result, it is able to control the display panel to display the corresponding image through these touch operations, thereby to facilitate the use of the touch display device by a disabled person.

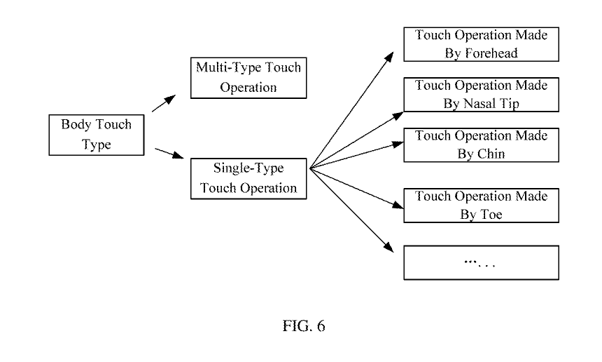

The touch display device further includes a sound feature signal database configured to store a correspondence between sound feature signals and body touch types. The body touch types include a single-type touch operation and a multi-type touch operation. As show in FIG. 6, the single-type touch operation refers to a touch operation made by a single body part, e.g., a touch operation made by a forehead, a touch operation made by a nasal tip, a touch operation made by a chin and a touch operation made by a toe. The multi-type touch operation refers to a combination of touch operations made by at least two body parts, e.g., it may include a combination of the above touch operations. Different sounds may be made in the case that different body parts are in contact with the display panel, and each body touch type corresponds to a unique sound feature signal. For example, a sound feature signal A corresponds to the touch operation made by the forehead, a sound feature signal B corresponds to the touch operation made by the nasal tip, a sound feature signal C corresponds to the touch operation made by the chin, a sound feature signal D corresponds to the touch operation made by the toe, a sound feature signal E corresponds to a combination of the touch operation made by the forehead and the touch operation made by the nasal tip, and a sound feature signal F corresponds to a combination of the touch operation made by the chin and the touch operation made by the nasal tip.

The central processor 20 is configured to acquire a sound feature signal in accordance with the sound vibration signal, and determine the body touch type corresponding to the sound feature signal in accordance with the correspondence. For example, in the case that the central processor 20 acquires the sound feature signal A in accordance with the sound vibration signal, it may determine that the body touch type is the touch operation made by the forehead. In the case that the central processor 20 acquires the sound feature signal B in accordance with the sound vibration signal, it may determine that the body touch type is the touch operation made by the nasal tip. In the case that the central processor 20 acquires the sound feature signal C in accordance with the sound vibration signal, it may determine that the body touch type is the touch operation made by the chin. In the case that the central processor 20 acquires the sound feature signal D in accordance with the sound vibration signal, it may determine that the body touch type is the touch operation made by the toe. In the case that the central processor 20 acquires the sound feature signal E in accordance with the sound vibration signal, it may determine that the body touch type is a combination of the touch operation made by the forehead and the touch operation made by the nasal tip. In the case that the central processor 20 acquires the sound feature signal F in accordance with the sound vibration signal, it may determine that the body touch type is a combination of the touch operation made by the chin and the touch operation made by the nasal tip.

The central processor 20 is further configured to acquire the sound feature signal in accordance with the received sound vibration signal, receive the body touch type corresponding to the sound vibration signal, and send the sound feature signal and the body touch type to the sound feature signal database. The sound feature signal database is further configured to update the correspondence between the sound feature signals and the body touch types in accordance with the received sound feature signal and body touch type. In this way, the sound feature signal database may not only store the correspondence between the sound feature signals and the body touch types but also update the correspondence between the sound feature signals and the body touch types. Further, a new correspondence between the sound feature signals and the body touch types may also be added into the sound feature signal database according to the practical need.

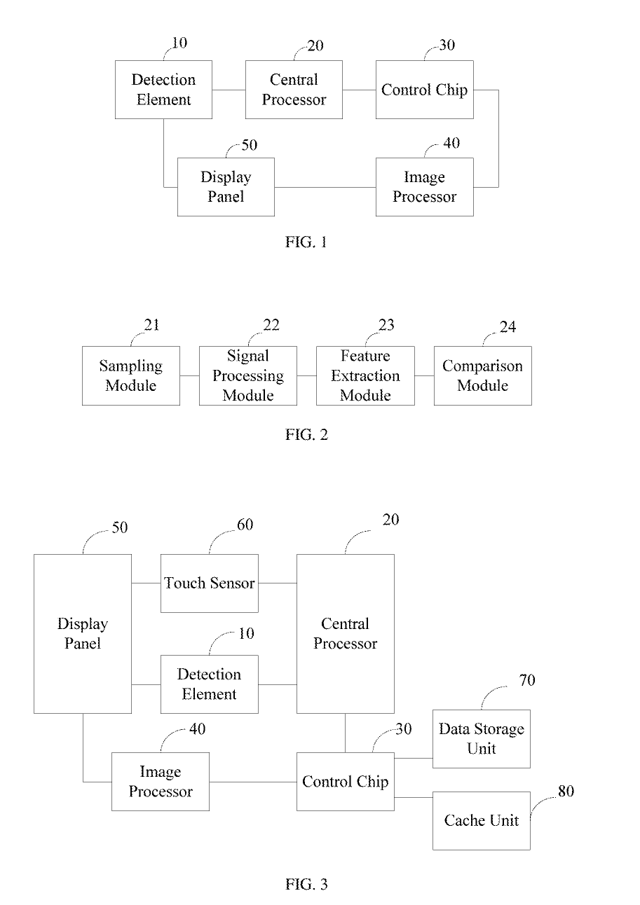

Further, as shown in FIG. 2, the central processor 20 includes: a sampling module 21 configured to receive the sound vibration signal from the detection element 10; a signal processing module 22 configured to process the sound vibration signal collected by the sampling module 21 and acquire a sound parameter of the sound vibration signal; a feature extraction module 23 configured to extract a feature from the sound vibration signal in accordance with the sound parameter acquired by the signal processing module 22, to obtain the sound feature signal; and a comparison module 24 configured to compare the acquired sound feature signal with data in the sound feature signal database, so as to determine the body touch type corresponding to the sound feature signal. In the case that a certain body part, e.g., the forehead, the chin or the nasal tip, is in contact with the display panel, the detection elements arranged on the display panel may generate the sound vibration signal. The sampling module is mainly configured to collect an original sound vibration signal generated in the case that the respective body part is in contact with the touch panel. This original sound vibration signal cannot be directly used to determine the body touch type. The signal processing module 22 may be configured to process the original sound vibration signal, e.g., through Fourier transformation, so as to acquire a principal, critical parameter, e.g., information about a characteristic amplitude and a characteristic frequency of the sound vibration signal.

The touch display device further includes a triggering event database configured to store a correspondence between body touch types and triggering events. For example, the touch operation made by the forehead corresponds to the determination function, the touch operation made by the chin corresponds to the cancellation function, the touch operation made by the nasal tip corresponds to the double-click function, and the touch operation made by the toe corresponds to the drawing function.

The control chip 30 is configured to compare the body touch type contained in the received instruction signal with information in the triggering event database, so as to determine the image data and the driving signal corresponding to the body touch type. For example, in the case that the central processor 20 determines the body touch type as the touch operation made by the forehead, the control chip 30 may send the image data and the driving signal corresponding to the determination function to the image processor, so as to drive the display panel to display an image corresponding to the determination function. In the case that the central processor 20 determines the body touch type as the touch operation made by the chin, the control chip 30 may send the image data and the driving signal corresponding to the cancellation function to the image processor, so as to drive the display panel to display an image corresponding to the cancellation function. In the case that the central processor 20 determines the body touch type as the touch operation made by the nasal tip, the control chip 30 may send the image data and the driving signal corresponding to the double-click function to the image processor, so as to drive the display panel to display an image corresponding to the double-click function. In the case that the central processor 20 determines the body touch type as the touch operation made by the toe, the control chip 30 may send the image data and the driving signal corresponding to the drawing function to the image processor, so as to drive the display panel to display an image corresponding to the drawing function.

As shown in FIG. 3, the touch display device further includes a data storage unit 70 connected to the control chip 30 and configured to store therein an instruction signal for a current frame received by the control chip 30. In this way, historical data may be recorded in the data storage unit 70.

The touch display device further includes a cache unit 80 connected to the control chip 30 and configured to cache an instruction signal for a next frame received by the control chip 30. In this way, for the next frame, the control chip 30 may directly generate the image data and the driving signal in accordance with the instruction signal cached in the cache unit 80, so as to identify the body part and trigger the touch operation quickly.

The cache unit 80, the data storage unit 70 and the image processor 40 may be connected to the control chip 30 via a bus.

According to the embodiments of the present disclosure, it is able to identify the body part that is in contact with the display panel. In this way, different touch operations may be made by different body parts, so as to control the display panel to display the corresponding image. For example, the determination function may be achieved through the touch operation made by the forehead, the cancellation function may be achieved through the touch operation made by the chin, the double-click function may be achieved through the touch operation made by the nasal tip, and the drawing function may be achieved through the touch operation made by the toe. As a result, it is able to control the display panel to display the corresponding image through these touch operations, thereby to facilitate the use of the touch display device by the disabled person.

The present disclosure further provides in some embodiments another touch display device which, as shown in FIG. 3, includes: a display panel 50; a plurality of detection elements 10 arranged on the display panel 50 and configured to acquire a sound vibration signal generated in the case that a respective body part is in contact with the display panel 50; a plurality of touch sensors 60 arranged on the display panel 50 and configured to acquire a coordinate position of a touch point in the case that the respective body part is in contact with the display panel 50; a central processor 20 connected to the detection elements 10 and the touch sensors 60 and configured to analyze the sound vibration signal delivered by the detection elements 10, determine a body touch type, and generate an instruction signal containing the body touch type and the coordinate position of the touch point; a control chip 30 connected to the central processor 20 and configured to receive the instruction signal from the central processor 20, and generate image data and a driving signal in accordance with the instruction signal; and an image processor 40 connected to the control chip 30 and configured to receive the image data and the driving signal from the control chip 30, and drive the display panel 50 to display a corresponding image. The detection elements 10 may be arranged on the display panel 50 in rows and columns. To be specific, the number of the detection elements depends on a sensing accuracy. In the case that a high sensing accuracy is desired, more detection elements may be provided, and in the case that a low sensing accuracy is desired, fewer detection elements may be provided. Specifically, the detection element may be a sound sensor. The touch sensors 60 may be arranged on the display panel 50 in rows and columns. To be specific, the number of the touch sensors depends on the sensing accuracy. In the case that a high sensing accuracy is desired, more touch sensors may be provided, and in the case that a low sensing accuracy is desired, fewer touch sensors elements may be provided.

According to the embodiments of the present disclosure, the plurality of detection elements and the plurality of touch sensors are arranged on the display panel, so as to acquire the sound vibration signal and the coordinate position of the touch point generated in the case that the respective body part is in contact with the display panel. Then, it is able to determine the body touch type in accordance with the sound vibration signal, so as to generate the image data and the driving signal corresponding to the body touch type and the coordinate position of the touch point, thereby to drive the display panel to display the corresponding image. In this way, it is able to achieve different touch operations in accordance with different body parts, thereby to control the display panel to display the corresponding image. For example, through the touch operation made by the forehead and the coordinate position of the touch point, it is able to perform a determination operation on an icon at the touch point where the forehead is in contact with the display panel. Through the touch operation made by the chin and the coordinate position of the touch point, it is able to perform a cancellation operation on an icon at the touch point where the chin is in contact with the display panel. Through the touch operation made by the nasal tip and the coordinate position of the touch point, it is able to perform a double-click operation on an icon at the touch point where the nasal tip is in contact with the display panel. Through the touch operation made by the toe and the coordinate position of the touch point, it is able to perform a zoom-in operation on an image at the touch point where the toe is in contact with the display panel. As a result, it is able to control the display panel to display the corresponding image through these touch operations, thereby to facilitate the use of the touch display device by the disabled person.

The touch display device further includes a sound feature signal database configured to store a correspondence between sound feature signals and body touch types. The body touch types include a single-type touch operation and a multi-type touch operation. The single-type touch operation refers to a touch operation made by a single body part, e.g., the touch operation made by the forehead, the touch operation made by the nasal tip, the touch operation made by the chin and the touch operation made by the toe. The multi-type touch operation refers to a combination of touch operations made by at least two body parts, e.g., it may include a combination of the above touch operations. Different sounds may be made in the case that different body parts are in contact with the display panel, and each body touch type corresponds to a unique sound feature signal. For example, a sound feature signal A corresponds to the touch operation made by the forehead, a sound feature signal B corresponds to the touch operation made by the nasal tip, a sound feature signal C corresponds to the touch operation made by the chin, a sound feature signal D corresponds to the touch operation made by the toe, a sound feature signal E corresponds to a combination of the touch operation made by the forehead and the touch operation made by the nasal tip, and a sound feature signal F corresponds to a combination of the touch operation made by the chin and the touch operation made by the nasal tip.

The central processor 20 is configured to acquire a sound feature signal in accordance with the sound vibration signal, and determine the body touch type corresponding to the sound feature signal in accordance with the correspondence. For example, in the case that the central processor 20 acquires the sound feature signal A in accordance with the sound vibration signal, it may determine that the body touch type is the touch operation made by the forehead. In the case that the central processor 20 acquires the sound feature signal B in accordance with the sound vibration signal, it may determine that the body touch type is the touch operation made by the nasal tip. In the case that the central processor 20 acquires the sound feature signal C in accordance with the sound vibration signal, it may determine that the body touch type is the touch operation made by the chin. In the case that the central processor 20 acquires the sound feature signal D in accordance with the sound vibration signal, it may determine that the body touch type is the touch operation made by the toe. In the case that the central processor 20 acquires the sound feature signal E in accordance with the sound vibration signal, it may determine that the body touch type is a combination of the touch operation made by the forehead and the touch operation made by the nasal tip. In the case that the central processor 20 acquires the sound feature signal F in accordance with the sound vibration signal, it may determine that the body touch type is a combination of the touch operation made by the chin and the touch operation made by the nasal tip.

The central processor 20 is further configured to acquire the sound feature signal in accordance with the received sound vibration signal, receive the body touch type corresponding to the sound vibration signal, and send the sound feature signal and the body touch type to the sound feature signal database. The sound feature signal database is further configured to update the correspondence between the sound feature signals and the body touch types in accordance with the received sound feature signal and body touch type. In this way, the sound feature signal database may not only store the correspondence between the sound feature signals and the body touch types but also update the correspondence between the sound feature signals and the body touch types. Further, a new correspondence between the sound feature signals and the body touch types may also be added into the sound feature signal database according to the practical need.

Further, as shown in FIG. 2, the central processor 20 includes: a sampling module 21 configured to receive the sound vibration signal from the detection element 10; a signal processing module 22 configured to process the sound vibration signal collected by the sampling module 21 and acquire a sound parameter of the sound vibration signal; a feature extraction module 23 configured to extract a feature from the sound vibration signal in accordance with the sound parameter acquired by the signal processing module 22, to obtain the sound feature signal; and a comparison module 24 configured to compare the acquired sound feature signal with data in the sound feature signal database, so as to determine the body touch type corresponding to the sound feature signal. In the case that a certain body part, e.g., the forehead, the chin or the nasal tip, is in contact with the display panel, the detection elements arranged on the display panel may generate the sound vibration signal. The sampling module is mainly configured to collect an original sound vibration signal generated in the case that the respective body part is in contact with the touch panel. This original sound vibration signal cannot be directly used to determine the body touch type. The signal processing module 22 may be configured to process the original sound vibration signal, e.g., through Fourier transformation, so as to acquire a principal, critical parameter, e.g., information about a characteristic amplitude and a characteristic frequency of the sound vibration signal.

The touch display device further includes a triggering event database configured to store a correspondence between coordinate positions of touch points as well as body touch types and triggering events. For example, a combination of the touch operation made by the forehead and the coordinate position of the touch position corresponds to a determination operation on an icon at the touch point, a combination of the touch operation made by the chin and the coordinate position of the touch point corresponds to a cancellation operation on an icon at the touch position, a combination of the touch operation made by the nasal tip and the coordinate position of the touch point corresponds to a double-click operation on an icon at the touch position, and a combination of the touch operation made by the toe and the coordinate position of the touch point corresponds to a zoom-in operation at an image at the touch point.

The control chip 30 is configured to compare the coordinate position of the touch point and the body touch type contained in the received instruction signal with information in the triggering event database, so as to determine the image data and the driving signal corresponding to the coordinate position of the touch point and the body touch type. For example, in the case that the central processor 20 determines the body touch type as the touch operation made by the forehead, the control chip 30 may send the image data and the driving signal corresponding to the determination operation on the icon at the touch point to the image processor, so as to drive the display panel to display an image corresponding to the determination function. In the case that the central processor 20 determines the body touch type as the touch operation made by the chin, the control chip 30 may send the image data and the driving signal corresponding to the cancellation operation on the icon at the touch point to the image processor, so as to drive the display panel to display an image corresponding to the cancellation function. In the case that the central processor 20 determines the body touch type as the touch operation made by the nasal tip, the control chip 30 may send the image data and the driving signal corresponding to the double-click operation on the icon of the touch point to the image processor, so as to drive the display panel to display an image corresponding to the double-click function. In the case that the central processor 20 determines the body touch type as the touch operation made by the toe, the control chip 30 may send the image data and the driving signal corresponding to the zoom-in operation on the image at the touch point to the image processor, so as to drive the display panel to display an image corresponding to the zoom-in function.

According to the embodiments of the present disclosure, it is able to identify the body part that is in contact with the display panel and the coordinate position of the touch point. In this way, different touch operations may be made by different body parts, so as to control the display panel to display the corresponding image. For example, the determination function may be achieved through the touch operation made by the forehead, the cancellation function may be achieved through the touch operation made by the chin, the double-click function may be achieved through the touch operation made by the nasal tip, and the zoom-in function may be achieved through the touch operation made by the toe. As a result, it is able to control the display panel to display the corresponding image through these touch operations, thereby to facilitate the use of the touch display device by the disabled person.

As shown in FIG. 3, the touch display device further includes a data storage unit 70 connected to the control chip 30 and configured to store therein an instruction signal for a current frame received by the control chip 30. In this way, historical data may be recorded in the data storage unit 70.

The touch display device further includes a cache unit 80 connected to the control chip 30 and configured to cache an instruction signal for a next frame received by the control chip 30. In this way, for the next frame, the control chip 30 may directly generate the image data and the driving signal in accordance with the instruction signal cached in the cache unit 80, so as to identify the body part and trigger the touch operation quickly.

The cache unit 80, the data storage unit 70 and the image processor 40 may be connected to the control chip 30 via a bus.

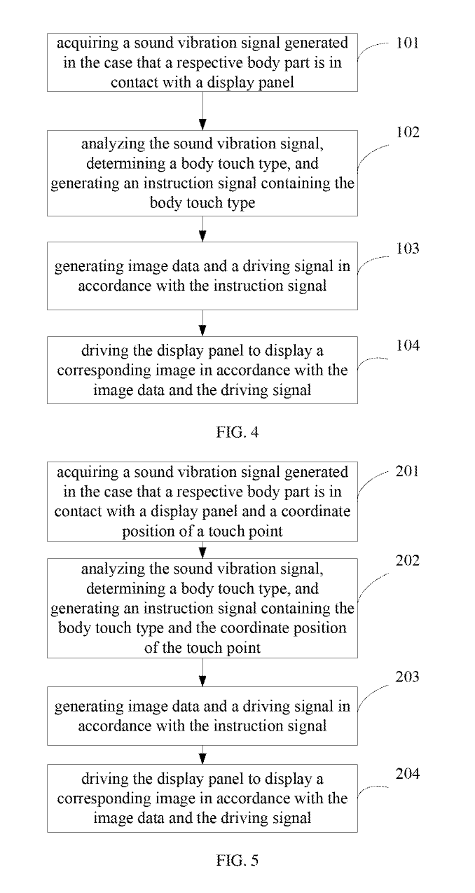

The present disclosure further provides in some embodiments a touch display method for use in the above-mentioned touch display device. As shown in FIG. 4, the touch display method includes the following steps.

Step 101: acquiring the sound vibration signal generated in the case that the respective body part is in contact with the display panel. The plurality of detection elements may be arranged on the display panel, and in the case that a touch operation is made by a user, it is able to acquire, by the sound sensors, different sound vibration signals generated in the case that the respective body part, e.g., the forehead, the chin or the nasal tip, is in contact with the touch panel.

Step 102: analyzing the sound vibration signal, determining the body touch type, and generating the instruction signal containing the body touch type.

The correspondence between the sound feature signals and the body touch types is stored in the sound feature signal database. The body touch types include a single-type touch operation and a multi-type touch operation. The single-type touch operation refers to a touch operation made by a single body part, e.g., a touch operation made by a forehead, a touch operation made by a nasal tip, a touch operation made by a chin and a touch operation made by a toe. The multi-type touch operation refers to a combination of touch operations made by at least two body parts, e.g., it may include a combination of the above touch operations. Different sounds may be made in the case that different body parts are in contact with the display panel, and each body touch type corresponds to a unique sound feature signal. For example, a sound feature signal A corresponds to the touch operation made by the forehead, a sound feature signal B corresponds to the touch operation made by the nasal tip, a sound feature signal C corresponds to the touch operation made by the chin, a sound feature signal D corresponds to the touch operation made by the toe, a sound feature signal E corresponds to a combination of the touch operation made by the forehead and the touch operation made by the nasal tip, and a sound feature signal F corresponds to a combination of the touch operation made by the chin and the touch operation made by the nasal tip.

The central processor may collect an original sound vibration signal, process the original sound vibration signal through Fourier transformation, acquire a principal, critical parameter such as information about a characteristic amplitude and a characteristic frequency of the sound vibration signal, extract a feature to acquire the sound feature signal, and determine the body touch type corresponding to the sound feature signal in accordance with the correspondence stored in the sound feature signal database. For example, in the case that the central processor acquires the sound feature signal A in accordance with the sound vibration signal, it may determine that the body touch type is the touch operation made by the forehead. In the case that the central processor acquires the sound feature signal B in accordance with the sound vibration signal, it may determine that the body touch type is the touch operation made by the nasal tip. In the case that the central processor acquires the sound feature signal C in accordance with the sound vibration signal, it may determine that the body touch type is the touch operation made by the chin. In the case that the central processor acquires the sound feature signal D in accordance with the sound vibration signal, it may determine that the body touch type is the touch operation made by the toe. In the case that the central processor acquires the sound feature signal E in accordance with the sound vibration signal, it may determine that the body touch type is a combination of the touch operation made by the forehead and the touch operation made by the nasal tip. In the case that the central processor acquires the sound feature signal F in accordance with the sound vibration signal, it may determine that the body touch type is a combination of the touch operation made by the chin and the touch operation made by the nasal tip.

After the body touch type has been identified, the central processor may send the instruction signal containing the body touch type to the control chip.

Step 103: generating the image data and the driving signal in accordance with the instruction signal.

The correspondence between the body touch types and the triggering events is stored in the triggering event database. For example, the touch operation made by the forehead corresponds to the determination function, the touch operation made by the chin corresponds to the cancellation function, the touch operation made by the nasal tip corresponds to the double-click function, and the touch operation made by the toe corresponds to the drawing function. The control chip may compare the body touch type contained in the received instruction signal with the information in the triggering event database, and determine the image data and the driving signal corresponding to the body touch type. For example, For example, in the case that the central processor determines the body touch type as the touch operation made by the forehead, the control chip may send the image data and the driving signal corresponding to the determination operation to the image processor, so as to drive the display panel to display an image corresponding to the determination function. In the case that the central processor determines the body touch type as the touch operation made by the chin, the control chip may send the image data and the driving signal corresponding to the cancellation function to the image processor, so as to drive the display panel to display an image corresponding to the cancellation function. In the case that the central processor determines the body touch type as the touch operation made by the nasal tip, the control chip may send the image data and the driving signal corresponding to the double-click function to the image processor, so as to drive the display panel to display an image corresponding to the double-click function. In the case that the central processor determines the body touch type as the touch operation made by the toe, the control chip may send the image data and the driving signal corresponding to the drawing function to the image processor, so as to drive the display panel to display an image corresponding to the drawing function.

Step 104: driving the display panel to display the corresponding image in accordance with the image data and the driving signal.

After the image data and the driving signal have been received from the control chip, the image processor may drive the display panel to display the corresponding image in accordance with the image data and the driving signal.

Further, the central processor may acquire the sound feature signal in accordance with the received sound vibration signal, receive the body touch type corresponding to the sound vibration signal, and send the sound feature signal and the body touch type to the sound feature signal database. The sound feature signal database may update the correspondence between the sound feature signals and the body touch types in accordance with the received sound feature signal and body touch type. In this way, the sound feature signal database may not only store the correspondence between the sound feature signals and the body touch types but also update the correspondence between the sound feature signals and the body touch types. Further, a new correspondence between the sound feature signals and the body touch types may also be added into the sound feature signal database according to the practical need.

According to the embodiments of the present disclosure, it is able to identify the body part that is in contact with the display panel. In this way, different touch operations may be made by different body parts, so as to control the display panel to display the corresponding image. For example, the determination function may be achieved through the touch operation made by the forehead, the cancellation function may be achieved through the touch operation made by the chin, the double-click function may be achieved through the touch operation made by the nasal tip, and the drawing function may be achieved through the touch operation made by the toe. As a result, it is able to control the display panel to display the corresponding image through these touch operations, thereby to facilitate the use of the touch display device by the disabled person.

The present disclosure further provides in some embodiments another touch display method for use in the above-mentioned touch display device. As shown in FIG. 5, the touch display method may include the following steps.

Step 201: acquiring the sound vibration signal generated in the case that the respective body part is in contact with the display panel and the coordinate position of the touch point. The plurality of detection elements may be arranged on the display panel, and in the case that a touch operation is made by a user, it is able to acquire, by the sound sensors, different sound vibration signals generated in the case that the respective body part, e.g., the forehead, the chin or the nasal tip, is in contact with the touch panel. The plurality of touch sensors may also be arranged on the display panel. In the case that a touch operation is made by a user, a change in the touch position may be acquired by the touch sensors, so as to determine the coordinate position of the touch point. The touch sensor may be a capacitive, a resistive or an optical sensor.

Step 202: analyzing the sound vibration signal, determining the body touch type, and generating the instruction signal containing the body touch type and the coordinate position of the touch point.

The correspondence between the sound feature signals and the body touch types is stored in the sound feature signal database. The body touch types include a single-type touch operation and a multi-type touch operation. The single-type touch operation refers to a touch operation made by a single body part, e.g., a touch operation made by a forehead, a touch operation made by a nasal tip, a touch operation made by a chin and a touch operation made by a toe. The multi-type touch operation refers to a combination of touch operations made by at least two body parts, e.g., it may include a combination of the above touch operations. Different sounds may be made in the case that different body parts are in contact with the display panel, and each body touch type corresponds to a unique sound feature signal. For example, a sound feature signal A corresponds to the touch operation made by the forehead, a sound feature signal B corresponds to the touch operation made by the nasal tip, a sound feature signal C corresponds to the touch operation made by the chin, a sound feature signal D corresponds to the touch operation made by the toe, a sound feature signal E corresponds to a combination of the touch operation made by the forehead and the touch operation made by the nasal tip, and a sound feature signal F corresponds to a combination of the touch operation made by the chin and the touch operation made by the nasal tip.

The central processor may collect an original sound vibration signal, process the original sound vibration signal through Fourier transformation, acquire a principal, critical parameter such as information about a characteristic amplitude and a characteristic frequency of the sound vibration signal, extract a feature to acquire the sound feature signal, and determine the body touch type corresponding to the sound feature signal in accordance with the correspondence stored in the sound feature signal database. For example, in the case that the central processor acquires the sound feature signal A in accordance with the sound vibration signal, it may determine that the body touch type is the touch operation made by the forehead. In the case that the central processor acquires the sound feature signal B in accordance with the sound vibration signal, it may determine that the body touch type is the touch operation made by the nasal tip. In the case that the central processor acquires the sound feature signal C in accordance with the sound vibration signal, it may determine that the body touch type is the touch operation made by the chin. In the case that the central processor acquires the sound feature signal D in accordance with the sound vibration signal, it may determine that the body touch type is the touch operation made by the toe. In the case that the central processor acquires the sound feature signal E in accordance with the sound vibration signal, it may determine that the body touch type is a combination of the touch operation made by the forehead and the touch operation made by the nasal tip. In the case that the central processor acquires the sound feature signal F in accordance with the sound vibration signal, it may determine that the body touch type is a combination of the touch operation made by the chin and the touch operation made by the nasal tip.

After the body touch type has been identified, the central processor may generate the instruction signal containing the body touch type and the coordinate position of the touch point, and send the instruction signal to the control chip.

Step 203: generating the image data and the driving signal in accordance with the instruction signal.

The correspondence between the coordinate positions of the touch points as well as the body touch types and the triggering events is stored in the triggering event database. For example, a combination of the touch operation made by the forehead and the coordinate position of the touch position corresponds to a determination operation on an icon at the touch point, a combination of the touch operation made by the chin and the coordinate position of the touch point corresponds to a cancellation operation on an icon at the touch position, a combination of the touch operation made by the nasal tip and the coordinate position of the touch point corresponds to a double-click operation on an icon at the touch position, and a combination of the touch operation made by the toe and the coordinate position of the touch point corresponds to a zoom-in operation at an image at the touch point.

The control chip may compare the body touch type and the coordinate position of the touch point contained in the received instruction signal with information in the triggering event database, so as to determine the image data and the driving signal corresponding to the coordinate position of the touch point and the body touch type. For example, in the case that the central processor determines the body touch type as the touch operation made by the forehead, the control 30 may send the image data and the driving signal corresponding to the determination operation on the icon at the touch point to the image processor, so as to drive the display panel to display an image corresponding to the determination function. In the case that the central processor determines the body touch type as the touch operation made by the chin, the control chip may send the image data and the driving signal corresponding to the cancellation operation on the icon at the touch point to the image processor, so as to drive the display panel to display an image corresponding to the cancellation function. In the case that the central processor determines the body touch type as the touch operation made by the nasal tip, the control chip may send the image data and the driving signal corresponding to the double-click operation on the icon of the touch point to the image processor, so as to drive the display panel to display an image corresponding to the double-click function. In the case that the central processor determines the body touch type as the touch operation made by the toe, the control chip may send the image data and the driving signal corresponding to the zoom-in operation on the image at the touch point to the image processor, so as to drive the display panel to display an image corresponding to the zoom-in function.

Step 204: driving the display panel to display the corresponding image in accordance with the image data and the driving signal.

After the image data and the driving signal have been received from the control chip, the image processor may drive the display panel to display the corresponding image in accordance with the image data and the driving signal.

Further, the central processor may acquire the sound feature signal in accordance with the received sound vibration signal, receive the body touch type corresponding to the sound vibration signal, and send the sound feature signal and the body touch type to the sound feature signal database. The sound feature signal database may update the correspondence between the sound feature signals and the body touch types in accordance with the received sound feature signal and body touch type. In this way, the sound feature signal database may not only store the correspondence between the sound feature signals and the body touch types but also update the correspondence between the sound feature signals and the body touch types. Further, a new correspondence between the sound feature signals and the body touch types may also be added into the sound feature signal database according to the practical need.

According to the embodiments of the present disclosure, it is able to identify the body part that is in contact with the display panel and the coordinate position of the touch point. In this way, different touch operations may be made by different body parts, so as to control the display panel to display the corresponding image. For example, the determination function may be achieved through the touch operation made by the forehead, the cancellation function may be achieved through the touch operation made by the chin, the double-click function may be achieved through the touch operation made by the nasal tip, and the zoom-in function may be achieved through the touch operation made by the toe. As a result, it is able to control the display panel to display the corresponding image through these touch operations, thereby to facilitate the use of the touch display device by the disabled person.

The functional members described in the specification are referred to as modules, so as to emphasize the independence of the implementation in a more particular manner.

According to the embodiments of the present disclosure, the modules or units may be implemented by software, so as to be executed by various processors. For example, an identified, executable code module or unit may comprise one or more physical or logical blocks including computer instructions, and the module can be constructed as an image, a process or a function. Even so, the executable codes of the identified modules or units are unnecessary to be physically located together, but may comprise different instructions stored in different locations. When these instructions are logically combined together, they form the modules or units and achieve the prescribed purposes of the modules or units.

Actually, the executable code module or unit may be a single instruction or a plurality of instructions, and can even be distributed at different code segments, in different programs, or across a plurality of memory devices. Also, operational data may be identified in the modules or units, implemented in any appropriate form, and organized in any data structure of an appropriate type. The operational data may be collected as a single data set, or distributed at different locations (including different memory devices), and may be at least partially present in a system or network merely as an electronic signal.

When the modules or units can be implemented by software, considering the current hardware level, a person skilled in the art can build a corresponding hardware circuit to achieve the corresponding function without taking the cost into account. The hardware circuit comprises a conventional very-large-scale integration (VLSI) circuit, a gate array, an existing semiconductor such as a logic chip and a transistor, or other discrete components. The modules or units may further be implemented by a programmable hardware device, such as a field-programmable gate array, a programmable array logic device and a programmable logic device.

In the embodiments of the present disclosure, the order of the steps is not limited to the serial numbers thereof. For a person skilled in the art, any change in the order of the steps shall also fall within the scope of the present disclosure if without any creative effort.

The above are merely the preferred embodiments of the present disclosure. Obviously, a person skilled in the art may make further modifications and improvements without departing from the spirit of the present disclosure, and these modifications and improvements shall also fall within the scope of the present disclosure.

1. A touch display device, comprising:
a display panel;
a plurality of detection elements arranged on the display panel and configured to acquire a sound vibration signal generated in the case that a respective body part is in contact with the display panel;
a central processor connected to the detection elements and configured to analyze the sound vibration signal delivered by the detection elements, determine a body touch type, and generate an instruction signal containing the body touch type;
a control chip connected to the central processor and configured to receive the instruction signal from the central processor, and generate image data and a driving signal in accordance with the instruction signal; and
an image processor connected to the control chip and configured to receive the image data and the driving signal from the control chip, and drive the display panel to display a corresponding image.

2. The touch display device according to claim 1, further comprising a sound feature signal database configured to store a correspondence between sound feature signals and body touch types, wherein the central processor is configured to acquire a sound feature signal in accordance with the sound vibration signal, and determine the body touch type corresponding to the sound feature signal in accordance with the correspondence.

3. The touch display device according to claim 2, wherein the central processor is further configured to acquire the sound feature signal in accordance with the received sound vibration signal, receive the body touch type corresponding to the sound vibration signal, and send the sound feature signal and the body touch type to the sound feature signal database, and
the sound feature signal database is further configured to update the correspondence between the sound feature signals and the body touch types in accordance with the received sound feature signal and body touch type.

4. The touch display device according to claim 1, wherein the body touch type comprises a single-type touch operation which is a touch operation made by a single body part and a multi-type touch operation which is a combination of touch operations made by at least two body parts.

5. The touch display device according to claim 2, wherein the central processor comprises:
a sampling module configured to receive the sound vibration signal from the detection element;
a signal processing module configured to process the sound vibration signal and acquire a sound parameter of the sound vibration signal;
a feature extraction module configured to extract a feature from the sound vibration signal in accordance with the acquired sound parameter, to obtain the sound feature signal; and
a comparison module configured to compare the acquired sound feature signal with data in the sound feature signal database, so as to determine the body touch type corresponding to the sound feature signal.

6. The touch display device according to claim 1, further comprising a triggering event database configured to store a correspondence between body touch types and triggering events, wherein the control chip is configured to compare the body touch type contained in the received instruction signal with information in the triggering event database, so as to determine the image data and the driving signal corresponding to the body touch type.

7. The touch display device according to claim 6, further comprising a plurality of touch sensors arranged on the display panel and configured to acquire a coordinate position of a touch point in the case that the respective body part is in contact with the touch panel, wherein the central processor is further connected to each touch sensor, and configured to generate the instruction signal containing the body touch type and the coordinate position of the touch point.

8. The touch display device according to claim 7, wherein the triggering event database is further configured to store a correspondence between coordinate positions of touch points as well as body touch types and triggering events, and
the control chip is configured to compare the body touch type and the coordinate position of the touch point contained in the received instruction signal with information in the triggering event database, so as to determine the image data and the driving signal corresponding to the body touch type and the coordinate position of the touch point.

9. The touch display device according to claim 1, further comprising a data storage unit connected to the control chip and configured to store therein an instruction signal for a current frame received by the control chip.

10. The touch display device according to claim 1, further comprising a cache unit connected to the control chip and configured to cache an instruction signal for a next frame received by the control chip.

11. A touch display method for use in the touch display device according to claim 1, comprising steps of:
acquiring a sound vibration signal generated in the case that a respective body part is in contact with a display panel;
analyzing the sound vibration signal, determining a body touch type, and generating an instruction signal containing the body touch type;
generating image data and a driving signal in accordance with the instruction signal; and
driving the display panel to display a corresponding image in accordance with the image data and the driving signal.

12. The touch display method according to claim 11, further comprising acquiring a coordinate position of a touch point in the case that the respective body part is in contact with the display panel, wherein the step of generating the instruction signal containing the body touch type comprises generating the instruction signal containing the body touch type and the coordinate position of the touch point.

13. The touch display device according to claim 2, further comprising a triggering event database configured to store a correspondence between body touch types and triggering events, wherein the control chip is configured to compare the body touch type contained in the received instruction signal with information in the triggering event database, so as to determine the image data and the driving signal corresponding to the body touch type.

14. The touch display device according to claim 3, further comprising a triggering event database configured to store a correspondence between body touch types and triggering events, wherein the control chip is configured to compare the body touch type contained in the received instruction signal with information in the triggering event database, so as to determine the image data and the driving signal corresponding to the body touch type.

15. The touch display device according to claim 4, further comprising a triggering event database configured to store a correspondence between body touch types and triggering events, wherein the control chip is configured to compare the body touch type contained in the received instruction signal with information in the triggering event database, so as to determine the image data and the driving signal corresponding to the body touch type.

16. The touch display device according to claim 5, further comprising a triggering event database configured to store a correspondence between body touch types and triggering events, wherein the control chip is configured to compare the body touch type contained in the received instruction signal with information in the triggering event database, so as to determine the image data and the driving signal corresponding to the body touch type.
